(19) United States
(12) Patent Application Publication
(10) Pub. No.: US 2005/0025941 A1
(43) Pub. Date: Feb. 3, 2005

(54) Ream wrap printed with removable coupons or promotional markings

(76) Inventor: Michael R. Nowak, Hilbert, WI (US)

Correspondence Address: Philip M. Weiss;Weiss & Weiss, Suite 201, 310 Old Country Road, Garden City, NY, 11530, US

(21) Appl. No.: 10/929,938

(22) Filed: Aug. 30, 2004

Related U.S. Application Data
(63) Continuation-in-part of application No. 10/616,590, filed on Jul. 10, 2003.

(51) Int. Cl. F16L 1/00

(52) U.S. Cl. 428/195.1; 428/34.1

(57) ABSTRACT

A ream wrapper and a method of producing a ream wrapper that is printed with manufacturer or retailer coupons or other promotional markings on the outside of the ream wrapper so that the coupon or promotional marking is easily removable by the consumer of wrapped paper without destroying the integrity of the wrapped ream.

### RELATED PATENT APPLICATIONS

The following patent application is a continuation in part of U.S. patent application Ser. No. 10/616,590 filed Jul. 10, 2003.

### FIELD OF THE INVENTION

The present invention relates to a ream wrapper and a method of producing a ream wrapper that is printed with manufacturer or retailer coupons or other promotional markings on the outside of the ream wrapper so that the coupon or promotional marking is easily removable by the consumer of wrapped paper without destroying the integrity of the wrapped ream.

### BACKGROUND OF THE INVENTION

Reams (i.e., 500 sheets) of cut paper (8½×11, etc.) for copy machines, computers, printers, and other home and office applications are most commonly packaged for shipping, storage, and retail sale in ream wrap made of various wrap materials, including coated papers and solid plastic films. In addition to keeping the paper contained in the package, the ream wrap provides a moisture barrier that prevents or delays the absorption of moisture by the wrapped paper. The wrap also presents the paper contained inside in an eye-appealing manner to the consumer. As more people have acquired home computers and printers, the use of copier and printer paper by individual consumers has increased. Individual consumers typically purchase individually wrapped reams of paper at an office supply store, retail store, or through an office supply catalog. Reams of copier and printer paper traditionally are purchased by offices, businesses, public institutions, and other high-volume users in larger boxed quantities. The ream wrapper itself is sold to paper mills, which make the copier or printer paper and package the reams on packaging lines. The ream wrap is often printed with the name of the paper mill or some other corporate logo or marking denoting the name of the paper manufacturer. Ream wrap also is sold under the names of equipment makers (i.e., Hewlett Packard, Xerox, etc.) or other private label resellers of reamed paper (i.e., Office Depot, Viking, Corporate Express, etc.). Such reams are wrapped in ream wrap printed with the name or corporate logo of the private label seller or equipment manufacturer.

Conventional ream wrappers include paper/polyethylene/paper laminates, paper/solid film laminates, paper/wax/paper laminates, polyethylene coated papers, wax-coated papers, and transparent polymer films.

### SUMMARY OF THE INVENTION

The present invention relates to a ream wrapper comprising one or more printed manufacturer or retailer coupon or coupon booklets which are included inside the wrapped ream of paper. It is an object of the invention for a printed advertisement to be placed on the ream wrapper notifying one of inclusion of coupons inside the ream wrapper.

The present invention relates to a ream wrapper comprising one or more printed manufacturer or retailer coupons which are printed on either the inside or outside of the wrapper. It is an object of the invention for the ream wrapper to further comprise solid or dotted lines for a user to cut out the coupons. It is an object of the present invention for the ream wrapper to further comprise perforations precut or pressed into the wrapper.

The present invention relates to a ream wrapper comprising one or more printed coupons which are attached to an inside surface or outside surface of the ream wrap. It is an object of the invention for the coupons to be attached using adhesive backing. It is an object of the invention for the ream wrap to be clear. It is an object of the present invention for the ream wrap to comprise a clear window.

The present invention relates to wrapped reams of paper with printed retailer or manufacturer coupons or coupon booklets inserted inside the ream, printed on the outside or inside of the ream wrap, or otherwise attached to the inside or outside of the wrapped ream. This method can capture the attention of the individual consumer of reamed papers—a marketplace that is particularly competitive with the proliferation of home, office and personal computers and printers.

The present invention relates to wrapped reams of copier and printer paper which include one or more promotional coupons or coupon booklets for a manufacturer or retailer of some other product. It is an object of the present invention to attract the particular attention of the consumer purchasing individually wrapped reams of paper for home, office or personal use. It is also an object of the invention to include coupons in or on wrapped reams sold to businesses, offices, public institutions, and other entities.

It is an object of the present invention to include one or more printed manufacturer or retailer coupons or coupon booklets inside the wrapped ream of paper. It also is an object of the invention to print one or more promotional coupons on either the inside or outside of the ream wrap itself so that the individual coupon are detachable by cutting with a scissor, or tearing along perforated lines, once the wrapped package is opened. It is a further object of the present invention to attach one or more printed manufacturer or retailer coupons to either the inside or outside of the wrapped reams by any means that makes the coupons easily detachable by the consumer or user of the paper (e.g., one embodiment may be a peel-away adhesive-backed coupon attached to either the inside or outside of the ream).

The present invention relates to laminated ream wrappers comprising a first layer of a paper substrate, a second layer of adhesive material, and a third layer of solid plastic film that is printed or reverse printed with the coupon or promotional marking on the outside of the ream wrapper. The present invention further relates to laminated ream wrappers, including two-layer film laminations, which are printed on the outside with a coupon or other promotional marking. It is an object of the present invention for the coupon or printed promotional marking to attract the attention of the individual consumers of wrapped papers.

It is an object of the present invention to remove the coupon or printed promotional marking without creating a hole in the inside layer of the laminated product.

The present invention relates to a ream wrapper that contains a manufacturer or retail coupon or other promotional marking (such as tickets, proof of purchase points, etc.) printed on the outside of the wrapper that is removable by the consumer. It is an object of the present invention to provide coupons or promotional markings that may be removed without opening the ream wrap package or creating a hole in the inside layer of the laminated product.

It is an object of the present invention to print or reverse print the coupon or promotional marking on the outside film layer of a laminated ream wrapper. It is an object of the present invention for the coupon or promotional marking to be outlined by a solid, dotted, or perforated line so that it is detachable by tearing along the lines. It is an object of the present invention for the coupon or promotional marking to be removable with no adhesive between the laminated areas in the zone where the coupon or promotional marking is printed. It is an object of the present invention for the inside layer (the layer that abuts the wrapped paper product) of the laminated ream wrapper to be intact and protect the product when the coupon or promotional marking is removed.

It is an object of the present invention for the coupon or promotional marking to be outlined by a solid, dotted, or perforated line that is placed on the folded end of the ream wrap or the top or bottom of the wrapper in a position so that the consumer can use a scissor to cut, tear, or remove the coupon or promotional marking without opening the wrapped product or penetrating the inside layer of the laminated ream wrapper. It is a further object of the invention for the coupon or promotional marking to be affixed in a way that it is torn from one corner or edge of the printed area and be torn and peeled away from the wrapped ream.

It is an object of the present invention to produce the ream wrapper by running the laminated product through the lamination process one time and not applying a glue or adhesive layer in the zone in which the printed coupon or promotional marking appears. This is known as registered printing/laminating process.

### BRIEF DESCRIPTION OF THE DRAWINGS

FIG. 1 is a top view of an embodiment of the present invention;

FIG. 1a is a sectional view of FIG. 1;

FIG. 2 is a top view of an embodiment of the present invention;

FIG. 3 is a top view of an embodiment of the present invention;

FIG. 4 is an internal view of an embodiment of the present invention;

FIG. 5 is a top view of an embodiment of the present invention;

FIG. 6 is a top view of an embodiment of the present invention;

FIG. 6a is a sectional view of FIG. 6;

FIG. 7 is a top view of an embodiment of the present invention;

FIG. 8 is a sectional view of FIG. 7;

FIG. 9 is a top view of an embodiment of the present invention;

FIG. 10 is a top view of an embodiment of the present invention;

FIG. 11 is a sectional view of FIG. 10;

FIG. 12 is a top view of an embodiment of the present invention; and

FIG. 13 shows an embodiment of an apparatus used to make ream wrap of the present invention.

### DETAILED DESCRIPTION OF THE INVENTION

In one embodiment of the present invention, one or more printed manufacturer or retailer coupons or coupon booklets (e.g., promoting the sale of an office product, or other retail or manufactured product—i.e., a fast food or nonfood consumer product) are included inside the wrapped ream of paper. Thus the coupons or coupon booklets are found inside with the cut paper when the consumer or user opens the ream. The printed ream wrapper may or may not include a printed advertisement for, or notification of, the inclusion of the coupons or coupon booklets on the outside of the wrapper itself in addition to other logos or corporate names or markings associated with the wrapped paper.

In another embodiment, the ream wrap is printed with one or more manufacturer or retailer coupons on either the inside or outside of the wrapper. Once the ream of paper is opened and prior to discarding the ream wrap, the consumer may cut out the coupons with a scissor or other means along solid or dotted lines. The coupon or coupons printed on the inside or outside of the label also may be enclosed within perforations pre-cut or pressed into the ream wrapper. The coupons are detachable by the consumer by tearing along the perforated lines. The ream wrap itself may be printed with an advertisement for the coupon or coupons on the outside of the wrapper.

In another embodiment, one or more detachable manufacturer or retailer coupons are mounted on either the inside or outside of the ream wrap by any well-known means. For instance, one or more printed coupons may be attached using an adhesive backing that allows the consumer to easily peel off the coupon or otherwise remove it from the ream wrap.

In another embodiment of the present invention, the inside of the ream wrapper is printed with a series of advertisements and/or coupons for a number of various retailers and manufacturers, in a manner similar to the coupons printed continuously across the back of grocery store and other retail cash register receipts or similar to advertisements printed in the church bulletin. Individual coupons are separated by printed solid or dotted lines along which the user or consumer can cut with a scissor or other means to detach the coupons.

In a further embodiment, a ream wrapper comprises an inside layer of paper, a second adhesive layer, and a third outside layer of plastic film printed or reverse printed with a coupon or promotional marking in addition to the graphics of the printed ream wrapper itself. The printed coupon or promotional marking is located on the outside of the package on the film layer, either on the bottom or top of the ream or along the top, bottom, or side edges of the package. In the area where the coupon or promotional marking is printed, no adhesive layer is added between the paper and film layers. The coupon or promotional marking may be outlined by a solid, dotted, and/or perforated line. The coupon or promotional marking is removable from the ream wrap package such that the top film layer on which the item is printed may be peeled, torn, or cut away from the inside paper layer of the laminated product. In this embodiment, no hole or piercing of the inside layer is made when the coupon or promotional marking is removed. The ream is still intact and the wrapper is protecting the paper product.

In another embodiment, a ream wrapper comprises an inside layer of plastic film, a second adhesive layer, and a third outside layer of plastic film printed or reverse printed with a coupon or promotional marking in addition to the graphics of the printed ream wrapper itself. The printed coupon or promotional marking is located on the outside film layer of the package, either on the bottom or top of the ream or along the top, bottom, or side edges of the package. In the area where the coupon or promotional marking is printed, no adhesive layer is added between the film layers. The coupon or promotional marking may be outlined by a solid, dotted, and/or perforated line. The coupon or promotional marking is easily removable from the ream wrap package such that the top film layer on which the item is printed or reverse printed may be peeled, torn, or cut away from the inside film layer of the laminated product. No hole or piercing of the inside layer is made when the coupon or promotional marking is removed. The ream is still intact and the wrapper is protecting the paper product.

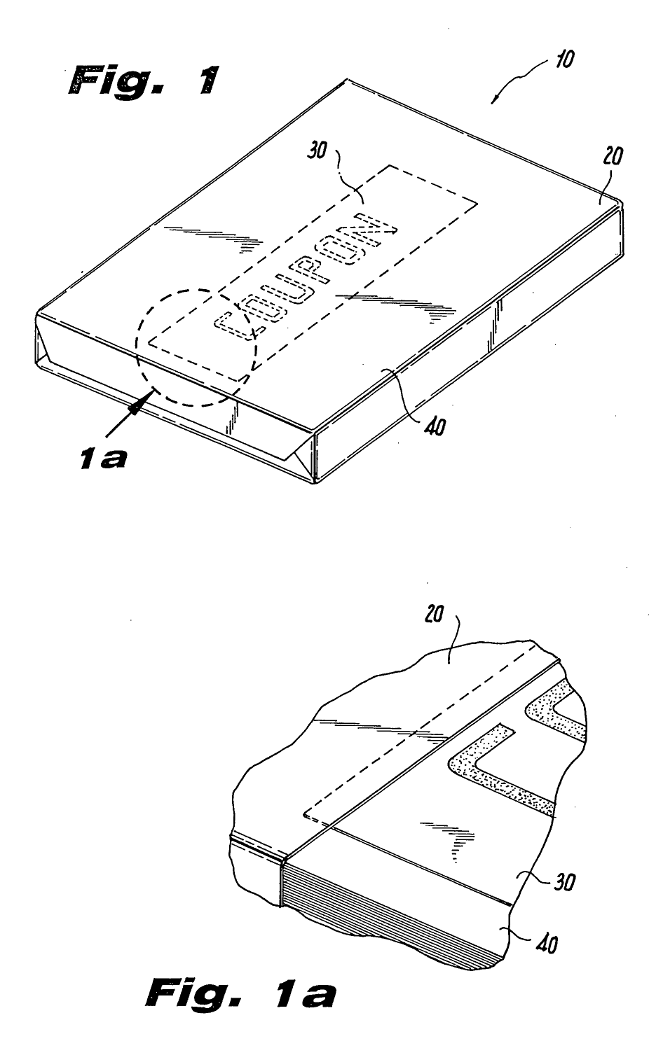

FIG. 1 illustrates a ream 10 comprising a clear ream wrapper 20 having coupons 30 placed on top of the paper 40. In this embodiment, a user can view both the paper 40 and the coupons 30. The coupons 30 can be removed from the ream wrapper 20 once the ream wrapper is opened.

FIG. 1a illustrates the clear ream wrap 20 having the coupon 30 underneath the ream wrap 20 and on top of the paper 40.

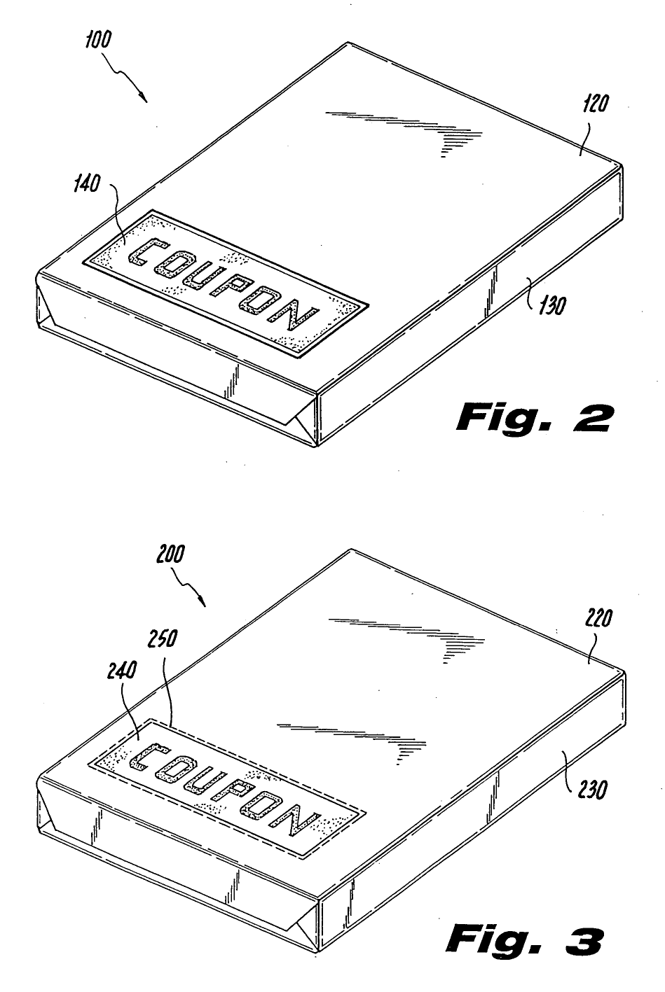

FIG. 2 illustrates a ream 100 comprising a ream wrapper 120 having a ream of paper 130 placed inside the ream wrapper. The ream wrapper 120 itself having coupons 140 printed directly on the wrapper.

FIG. 3 illustrates a ream 200 comprising a ream wrapper 220 having a ream of paper 230 placed inside the ream wrapper. The ream wrapper 220 has a coupon 240 attached to the wrapper by perforations 250.

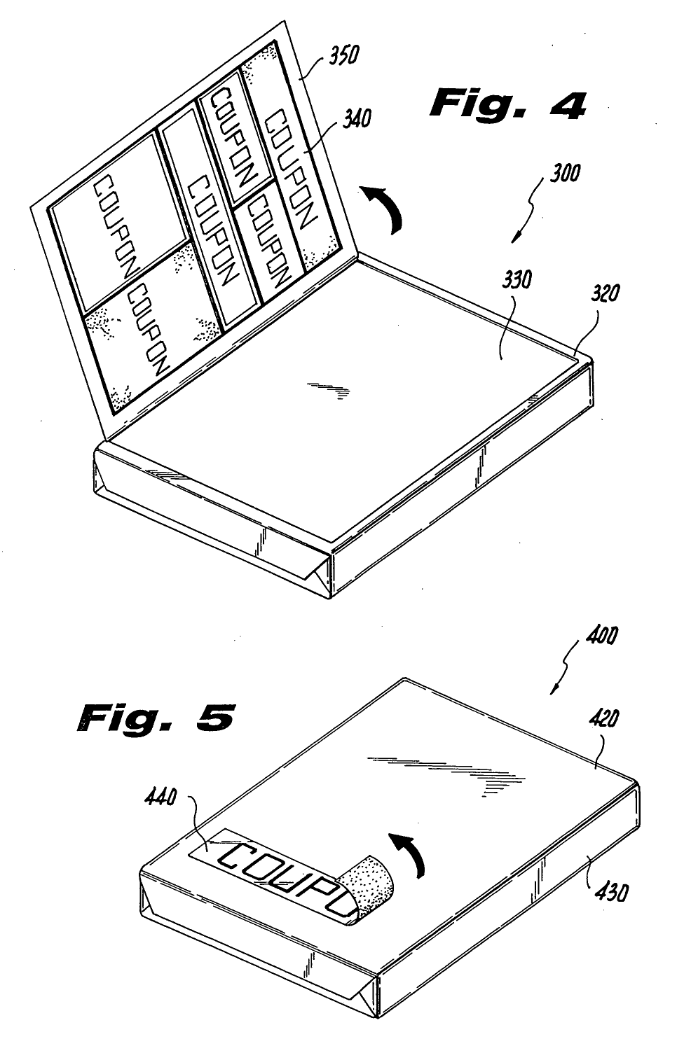

FIG. 4 illustrates a ream 300 comprising a ream wrapper 320 having a ream of paper 330 placed inside the ream wrapper. Coupons 340 are attached to the inside sheet 350 of the ream wrapper 320. An example of such attachment can be adhesive or tape.

FIG. 5 illustrates a ream 400 comprising a ream wrapper 420 having a ream of paper 430 placed inside the ream wrapper. Coupon 440 is attached by an adhesive to the ream wrap 420 so that the coupon can be peeled off the ream wrap.

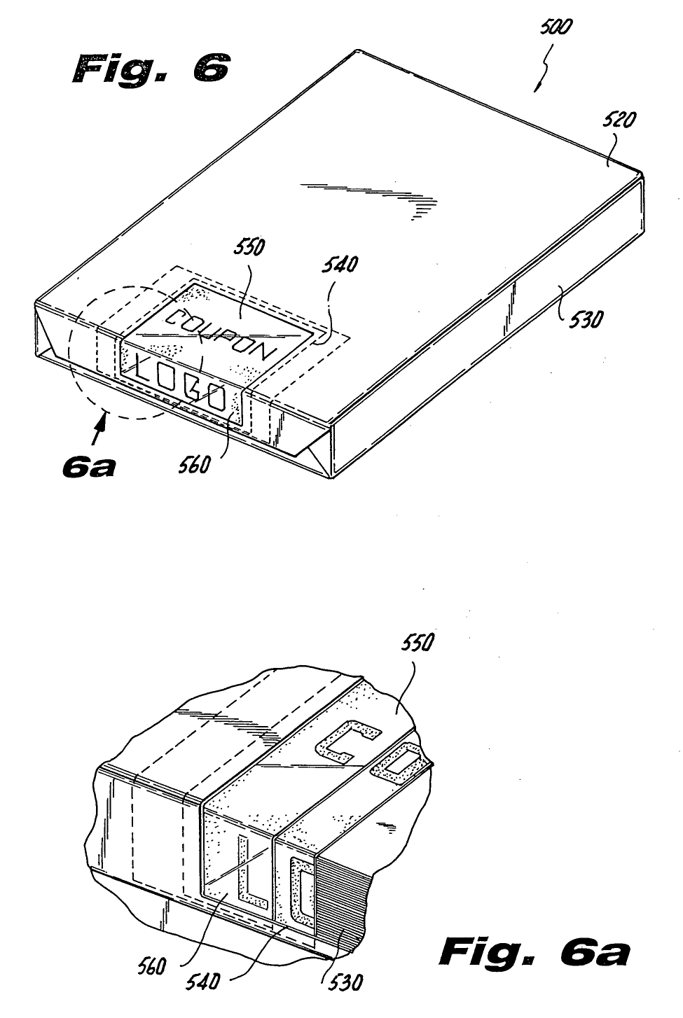

FIG. 6 illustrates a ream 500 comprising a ream wrapper 520 having a ream of paper 530 placed inside the ream wrapper. A clear window 540 is part of the ream wrapper 520 which allows coupon 550 and logo 560 to be shown to a customer. Further, the paper 530 can also be seen through window 540. In this embodiment, a user can see the coupon or logo by viewing the side of the ream wrap which usually faces the customer.

FIG. 6a illustrates the paper 530 and the window 540 which allows a user to see the coupon 550 and logo 560.

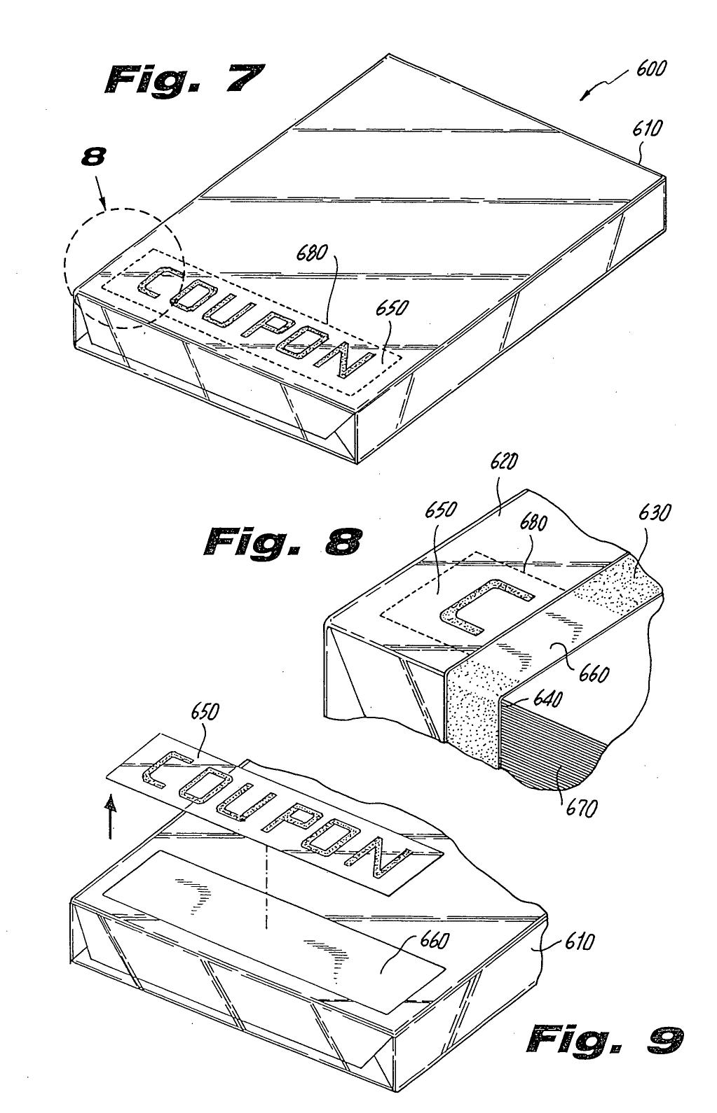

FIGS. 7 and 8 illustrate a ream 600 comprising a ream wrapper 610 which is comprised of an outer film layer 620 and adhesive layer 630 and a paper layer 640. A coupon 650 is part of the film layer 620 but is not attached to the paper layer 640 by adhesive layer 630. Section 660 does not have an adhesive layer. Ream wrapper 610 wraps around the ream of paper 670.

Outer film layer 620 is printed or reverse printed with a coupon or promotional marking 650 in addition to the graphics of the printed ream wrapper itself. The coupon or promotional marking 650 may be outlined by a solid, dotted, and/or perforated line 680. As shown in FIG. 9, the coupon or promotional marking 650 is removable from the ream wrap package 610 such that the top film layer 620 on which the item is printed may be peeled, torn, or cut away from the inside paper layer 640 of the laminated product. In this embodiment, no hole or piercing of the inside layer 640 is made when the coupon or promotional marking 650 is removed.

FIGS. 10 and 11 illustrate a ream 700 comprising a ream wrapper 710 which is comprised of an outer film layer 720 and adhesive layer 730 and a film layer 740. A coupon 750 is part of the film layer 720 but is not attached to the film layer 740 by adhesive layer 730. Section 760 does not have an adhesive layer. Ream wrapper 710 wraps around the ream of paper 770.

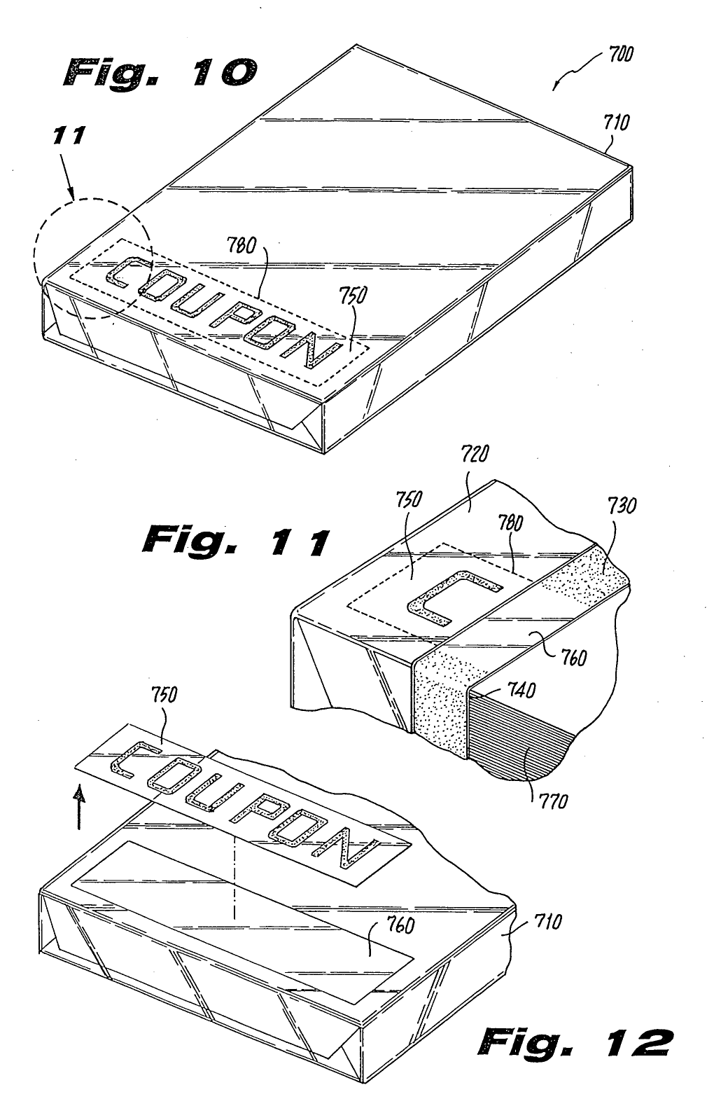

Outer film layer 720 is printed or reverse printed with a coupon or promotional marking 750 in addition to the graphics of the printed ream wrapper itself. The coupon or promotional marking 750 may be outlined by a solid, dotted, and/or perforated line 780. As shown in FIG. 12, the coupon or promotional marking 750 is removable from the ream wrap package 710 such that the top film layer 720 on which the item is printed may be peeled, torn, or cut away from the inside film layer 740 of the laminated product. In this embodiment, no hole or piercing of the inside layer 740 is made when the coupon or promotional marking 750 is removed.

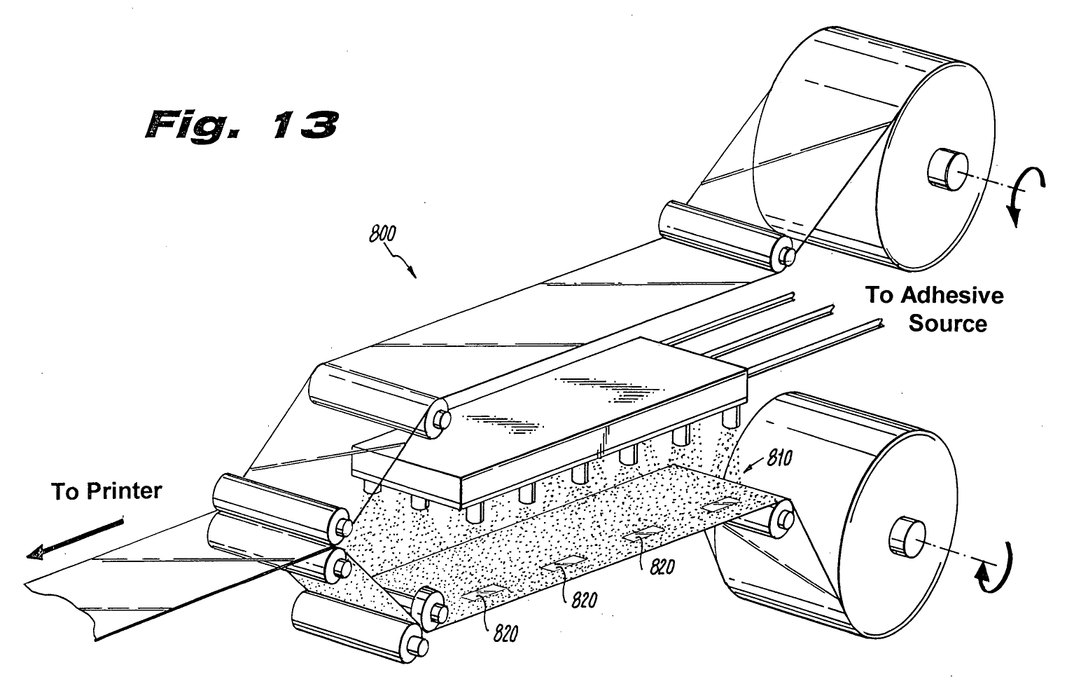

FIG. 13 shows an apparatus 800 for making the ream wrap of the present invention. FIG. 13 shows the ream wrapper being produced by running the laminated product through the lamination process one time and not applying a glue or adhesive layer 810 in the zone 820 in which the printed coupon or promotional marking appears. This is known as registered printing/laminating process.

1. A ream wrapper for cut paper comprising:
a first layer of paper;
a second layer of glue or adhesive material;
a third layer of plastic film;
wherein said ream wrapper is printed or reverse printed on said outside third layer with a coupon or other promotional marking that appears on outside of wrapped product.

2. The ream wrapper of claim 1 wherein said coupon or promotional marking is printed in an area where the second layer of adhesive or glue is not added between said first paper layer and said third outside film layer.

3. The ream wrapper of claim 1 wherein said ream wrapper is zone coated or registered using adhesive or glue between said first and third layers except in area in which said coupon or promotional marking is printed on said third outside film layer.

4. The ream wrapper of claim 1 wherein said coupon or promotional marking is removed without creating a hole in said first layer.

5. The ream wrapper of claim 1 wherein said coupon or promotional marking is outlined by a solid, dotted or perforated line.

6. A ream wrapper for cut paper comprising:
a first layer of plastic film;
a second layer of glue or adhesive material;
a third layer of plastic film;
wherein said ream wrapper is printed or reverse printed on said outside third layer with a coupon or other promotional marking that appears on outside of wrapped product.

7. The ream wrapper of claim 6 wherein said coupon or promotional marking is printed in an area where the second layer of adhesive or glue is not added between said first film layer and said third outside film layer.

8. The ream wrapper of claim 1 wherein said ream wrapper is zone coated or registered using adhesive or glue between said first and third layers except in area in which said coupon or promotional marking is printed on said third outside film layer.

9. The ream wrapper of claim 6 wherein said coupon or promotional marking is removed without creating a hole in said first layer.

10. The ream wrapper of claim 6 wherein said coupon or promotional marking is outlined by a solid, dotted or perforated line.

11. A method of producing a ream wrap comprising:
zone coating or registered laminating a glue or adhesive layer between an outside film layer and an inside layer comprising a film or paper layer except across an area or zone in which a coupon or promotional marking is to be printed.
